(19) United States
(12) Patent Application Publication
(10) Pub. No.: US 2017/0039787 A1
(43) Pub. Date: Feb. 9, 2017

(54) METHOD FOR MANAGING HEALTH OF MACHINE

(71) Applicant: Caterpillar Inc., Peoria, IL (US)

(72) Inventors: Akila Sukumaaran, Chennai (IN); Pradeep C. Ramakrishnan, Chennai (IN); Ramakrishna Challa, Narasaraopet (IN)

(73) Assignee: Caterpillar Inc., Peoria, IL (US)

(21) Appl. No.: 15/333,477

(22) Filed: Oct. 25, 2016

(51) Int. Cl. G07C 5/08; G06K 9/00; G06T 11/60

(52) U.S. Cl. CPC G07C 5/0825; G06T 11/60; G06K 9/00671; G07C 5/0808; G07C 5/085

(57) ABSTRACT

A method for parts management of a machine is provided. The method includes receiving operational information, identification information, and visual information associated with a plurality of components of the machine. The method further includes capturing visual information associated with at least a portion of the machine. The portion of the machine includes one or more target components. The method includes analyzing the visual information associated with the portion of the machine and the visual information associated with the plurality of components of the machine, to identify the one or more target components from the plurality of components. The method further includes displaying, using augmented reality, the operational information and the identification information associated with the one or more target components superimposed with the visual information associated with the one or more target components on the mobile inspection device.

### TECHNICAL FIELD

The present disclosure relates to machines, and more specifically to a method for managing health of a machine.

### BACKGROUND

Machines, such as excavators, dump trucks, or other earthmoving machines, include a large number of components that cooperate with each other to perform variety of tasks. Failure of one or more components of a machine is undesirable as it may lead to lower performance of the machine or increased machine downtime. Therefore, the components of the machine require regular inspection for maintenance, repair, or replacement purposes. Typically, inspection of the components of the machine is performed manually or by obtaining component diagnostic information through a diagnostic system. However, such manual inspection of the components or inspection based on component diagnostic information may be a cumbersome task, since the machine includes a large number of components and subcomponents. Further, tracking of replaced components for updating a bill of material also requires undesirable amount of time.

U.S. Pat. No. 9,187,188, hereinafter referred to as '188 patent, describes a method for inspecting assembly of components. The method for inspecting assembly of components in a structure includes acquiring a visual representation of at least a portion of the structure, and saving an electronic file of the visual representation on a computer readable medium. A three-dimensional design of the structure, which contains information on a proper position of the components within the structure, is accessed. The visual representation is compared with the three-dimensioned design using a computer, and a feedback indicating a result of the comparison is venerated. However, the '188 patent does not disclose inspection of health status of components in the structure.

### SUMMARY OF THE DISCLOSURE

In one aspect of the present disclosure, a method for managing health of a machine. The method includes receiving operational information, identification information, and visual information associated with a plurality of components of the machine. The operational information, the identification information, and the visual information are indicative of health of the plurality of components of the machine. The method further includes capturing, via a mobile inspection device, visual information associated with at least a portion of the machine. The portion of the machine includes one or more target components. The method includes analyzing the visual information associated with the portion of the machine and the visual information associated with the plurality of components of the machine, to identify the one or more target components from the plurality of components. The method further includes displaying, using augmented reality, the operational information and the identification information associated with the one or more target components superimposed with the visual information with the one or more target components on the mobile inspection device.

Other features and aspects of this disclosure will be apparent from the following description and the accompanying drawings.

### BRIEF DESCRIPTION OF THE DRAWINGS

FIG. 1 is a schematic side view of an exemplary machine, according to an embodiment of the present disclosure;

FIG. 2 is a block diagram of a machine inspection system in communication with the machine of FIG. 1;

FIG. 3 is a graphical representation of a Graphical User interface (GUI) of a mobile inspection device of the machine inspection system of FIG. 2, showing components of the machine and virtual overlapping information pertaining to the components; and

FIG. 4 is a block diagram for a method for managing health of the machine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

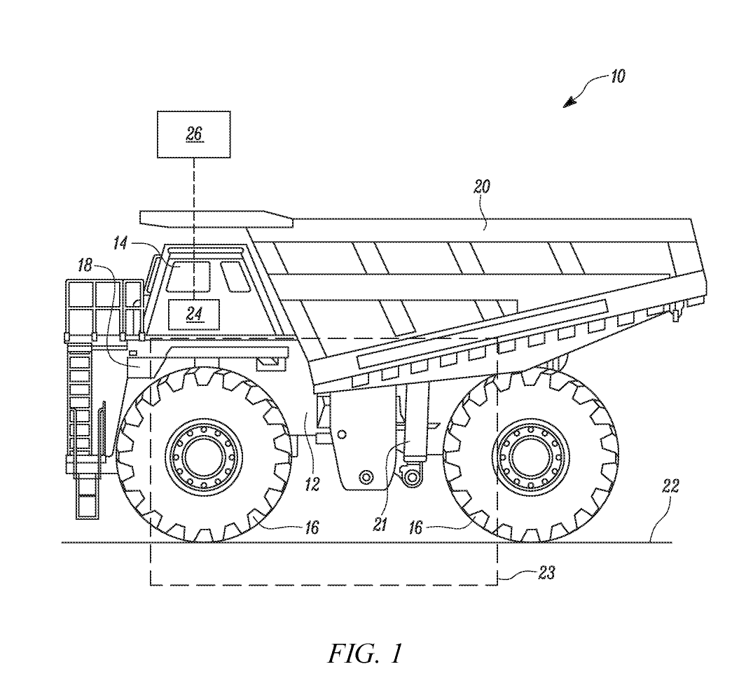

FIG. 1 illustrates a schematic view of an exemplary machine 10, according to an embodiment of the present disclosure. The machine 10 is embodied as an off-highway truck. In various examples, the machine 10 may be any mobile machine that performs operations associated with industries such as mining, construction, farming, transportation, or any other industry known in the art. For example, the machine 10 may be an excavator, a tractor, a loader, a motor grader, or any other earth moving machine.

The machine 10 includes a frame 12, an operator cabin 14 disposed on the frame 12, a pair of ground engaging members 16 for propelling the machine TO, a compartment 18 supported on the frame 12, a payload carrier 20 coupled to the frame 12, and a hydraulic actuator 21 for operating the payload carrier 20. The ground engaging members 16 is embodied as wheels which are in contact with a ground surface 22 for moving the machine 10 on the ground surface 22.

Although not shown, the machine 10 also includes a number of components, such as shock absorbers, a engine cooling fan, a radiator, an oil filters, an engine, hydraulic actuators, and air filters of the machine 10. In an example, the components of the machine 10 may include sub-components, for example the engine includes a cylinder block as a sub-component. In an example, the components of the machine 10 may operate in association with each other to perform various operations of the machine 10. The components of the machine 10 are located at various portions of the machine 10. For example, the ground engaging members 16 and the hydraulic actuator 21 may be located at a portion, such as a portion 36, interchangeably referred to as target portion 36, of the machine TO.

The operator cabin 14 of the machine 10 includes a number of input devices (not shown) to control various operations of the machine 10. The operator cabin 14 also accommodates an operator to operate the machine 10. In an example, the input devices may include, but are not limited to, a push button, a control lever, and a steering wheel. The input devices are provided to control a movement of the machine 10 and a movement of the payload carrier 20 with respect to the frame 12 of the machine 10. The compartment 18 of the machine 10 encloses a power source (not shown) to provide power to a main drive system (not shown) of the machine 10. In an example, the power source may be a mechanical power output source or an electrical power output source.

As shown in FIG. 1, the machine 10 also includes an Electronic Control Module (ECM) 24. In an example, the ECM 24 may be a processor including a single processing unit or a number of processing units, all of which may include multiple computing units. The explicit use of term ‘processor’ should not be construed to refer exclusively to hardware capable of executing a software application. Rather, in this example, the ECM 24 may be implemented as one or more microprocessors, microcomputers, digital signal processor, central processing units, state machine, logic circuitries, and/or any device that is capable of manipulating signals based on operational instructions. Among the capabilities mentioned herein, the ECM 24 may also be configured to receive, transmit, and execute computer-readable instructions.

The ECM 24 is in communication with the components of the machine 10. In one example, the ECM 24 may be in communication with the components of the machine 10 via Bluetooth Low Energy (BLE) tags (not shown) attached to the components. In another example, the ECM 24 may be in communication with the components of the machine 10 via CAN bus or any other medium known in the art, without departing from the scope of the present disclosure.

The ECM 24 is configured to receive operational information, identification information, and visual information associated with the components of the machine 10 from the BLE tags attached to the components of the machine TO. In an example, the ECM 24 may be configured to receive only the identification information associated with the components from the BLE tags such an example, the operational information and the visual information associated with the components may be pre-stored in the ECM 24 of the machine 10.

The operational information is indicative of data pertaining to operating status associated with the components of the machine 10. More specifically, the operational information is indicative of data pertaining to operating parameters associated with the components of the machine 10. The operational parameters may include, but is not limited to, fluid pressure, motor speed, operating temperatures, fluid levels, fault codes or any other parameter associated with operation of the components of the machine 10. For example, the operational parameters associated with the hydraulic actuator 21 (shown in FIG. 1) of the machine TO may include, but is not limited to, a fluid pressure and fluid levels of the hydraulic actuator 21. In an example, the operational information may be indicative of historical data pertaining to operational parameters associated with the components of the machine 10.

The identification information is indicative of data pertaining to identifying parameters associated with the components of the machine 10. The identifying parameters may include, but is not limited to, a part number, a component serial number, a component service history, a component name, a component service schedule, a component service life, a component installation time, a component service status, a Service Management Control System (SMCS) code or any other information assigned to the components of the machine 10. For example, the identifying parameters pertaining to the hydraulic actuator 21 of the machine 10 may include, but is not limited to, the part number as “205171”, the component serial number as “TOOL1”, and the component name as “hydraulic actuator”. In another example, the identifying parameter pertaining to one of the ground engaging members 16 of the machine 10 may include, but is not limited to, the part number as “206718”, the component serial number “TOOL2”, and the component name as “Wheel”. In yet another example, the identifying parameter pertaining to one of the ground engaging members 16 of the machine 10 may include, but is not limited to, the component service status as “newly installed”.

The visual information is indicative of data pertaining to reference images associated with the components of the machine 10. Each of the reference images is associated with each of the components of the machine 10. In an example, the reference images may also include three-dimensional geometric models of the components of the machine 10. For example, the reference image associated with the hydraulic actuator 21 may include a three-dimensional geometric model of the hydraulic actuator 21.

In an example, the ECM 24 may store the identification information, the operational information, and the visual information received from the components of the machine 10. In an example, the ECM 24 may store the identification information and the operational information received from the components in a form of bill of material of the components. In one example, the visual information associated with the components of the machine 10 may be pre-stored in a memory (not shown) of the ECM 24 of the machine 10. In another example, the visual information associated with the components may be pre-stored in an external data repository (not shown).

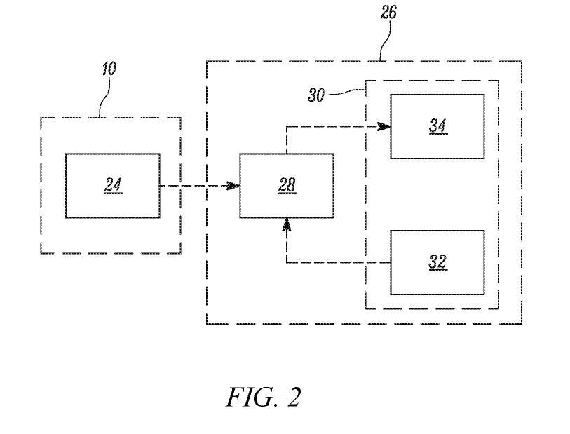

The operational information, the identification information, and the visual information collectively indicate health of the components of the machine 10. The health of the components herein referred to a working condition of the components of the machine 10. The ECM 24 is in communication with a machine inspection system 26 for managing health of the machine 10, which will be described in detail with reference to FIG. 2. More specifically, the ECM 24 is in wireless communication with the machine inspection system 26.

FIG. 2 illustrates a block diagram of the machine inspection system 26 in communication with the machine 10. The machine inspection system 26 is provided for managing health of the machine 10. Referring to FIGS. 1 and 2, the machine inspection system 26 includes a controller 28 and a mobile inspection device 30. The controller 28 is configured to establish communication with the ECM 24 of the machine 10. More specifically, the controller 28 is configured to establish a wireless communication with the ECM 24 of the machine 10, when the machine 10 is located within a range of the machine inspection system 26. The controller 28 is configured to receive the operational information, the identification information, and the visual information associated with the components from the ECM 24 of the machine 10. In one example, the controller 28 may be a controller of the mobile inspection device 30. In another example, the controller 28 may be a controller of a remote server (not shown).

In an example, the controller 28 may be implemented as one or more microprocessors, microcomputers, digital signal processors, central processing units, state machines, logic circuitries, and/or any device that is capable of manipulating signals based on operational instructions. Among the capabilities mentioned herein, the controller 28 may also be configured to receive, transmit, and execute computer-readable instructions. The controller 28 may also include a processor (not shown) that includes one or more processing units, all of which include multiple computing units. The processor may be implemented as hardware, software, or a combination of hardware and software capable of executing a software application.

Further, the mobile inspection device 30 is in communication with the ECM 24 of the machine 10. In an example, the mobile inspection device 30 may embody a mobile device, a laptop, a tablet or any other portable device with image capturing capabilities. The mobile inspection device 30 includes an image capturing unit 32 and a display unit 34. In an example, the image capturing unit 32 of the mobile inspection device 30 may be embodied as a camera. The image capturing unit 32 is configured to capture visual information, interchangeably referred to as target visual information, associated with a portion of the machine 10. In an example, the target visual information may include, but is not limited to, an image or a video. The portion of the machine 10 includes a number of target components from the components of the machine 10. The portion of the machine 10 represents a region of the machine 10 where the target components are located in the machine 10. The term “target components” herein refer to those components of the machine 10 which are required to be inspected.

In an example, the target visual information of the portion of the machine 10 to be captured may selected by the maintenance personal based on the location of the target components to be inspected. For example, in order to inspect the hydraulic actuator 21, the maintenance personal may capture the target visual information of the portion, such as the target portion 23 (shown in FIG. 1), of the machine 10 using the mobile inspection device 30 where the hydraulic actuator 21 is located.

The image capturing unit 32 is in communication with the controller 28. The image capturing unit 32 is configured to transmit the target visual information associated with the portion of the machine 10 to the controller 28. The controller 28 analyzes the target visual information associated with the portion of the machine 10 received from the image capturing unit 32 and the visual information associated with the plurality of components received from the ECM 24 using any known image processing techniques. More specifically, the controller 28 analyzes the image associated with the portion of the machine 10 and the three-dimensional geometric models of the components using any known image processing techniques.

Based on the analysis, the controller 28 identifies the target components from the components of the machine 10. More specifically, based on the analysis, the controller 28 identifies a type of the components captured by the image capturing unit 32 in the target visual information associated with the portion of the machine 10. For example, the portion, such as the target portion 23, of the machine 10 may include the hydraulic actuator 21 and one of the ground engaging members 16 as the target components to be inspected. In such an example, the controller 28 may analyze the target visual information of the target portion 23 of the machine 10 and the visual information of the components of the machine 10 to identify the target components. More specifically, in such an example, the controller 28 may analyze the image of the target portion 23 of the machine 10 and the reference images of the components of the machine 10 to identify the target components. Further, in such an example, the controller 28 identifies the target components as the hydraulic actuator 21 and one of the ground engaging members 16 exhibiting in the target visual information of the target portion 23 of the machine 10.

Based on the identification of the target components, the controller 28 transmits the operational information and the identification information associated with the target components to the display unit 34 of the mobile inspection device 30. More specifically, based on the identification of the target components, the controller 28 transmits the operational information and the identification information associated with the target components displayed in the display unit 34 of the mobile inspection device 30. In an example, the controller 28 may identify that the target components in the target visual information of the portion, such as the target portion 23, of the machine 10 as the hydraulic actuator 21 and one of the ground engaging members 16. In such an example, the operational information, such as the fluid pressure and the fluid levels, and the identification information, such as “205171”, “TOOL1”, and “hydraulic actuator”, associated with the hydraulic actuator 21 of the machine 10 are displayed by the display unit 34. Further, the operational information, such as tire pressure and tire temperature, and the identification information, such as “206718”, “TOOL2”, and “Wheel”, associated with one of the ground engaging members 16 of the machine 10 is also displayed by the display unit 34.

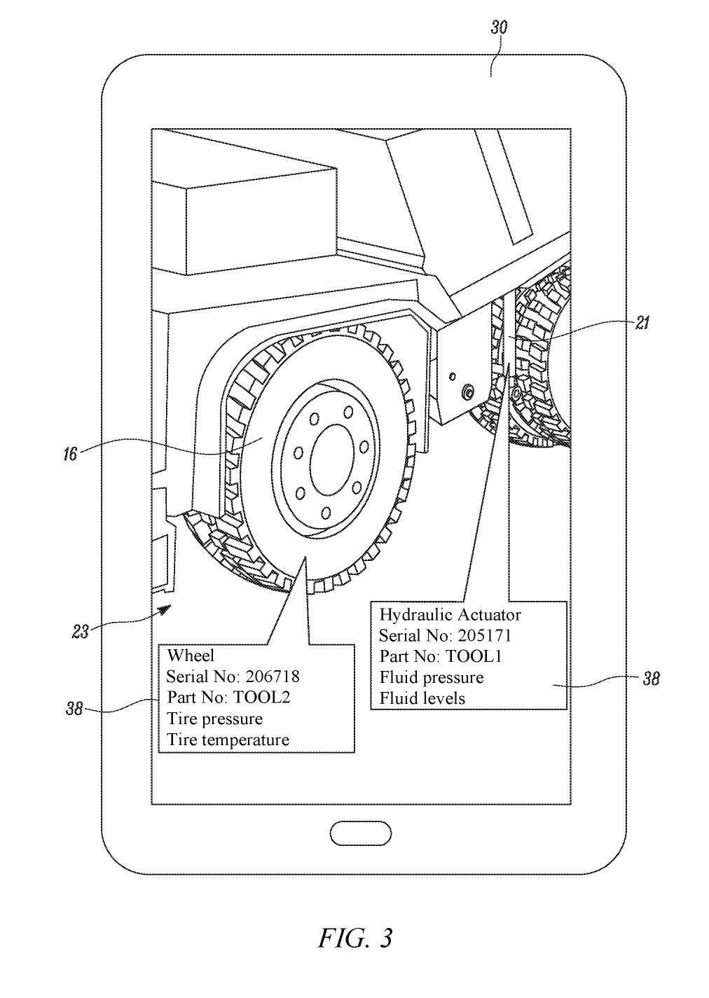

FIG. 3 is a graphical representation of an exemplary Graphical User Interface (GUI) of the mobile inspection device 30 showing the portion, such as the target portion 23, of the machine 10 and virtual overlapping information 38. The display unit 34 is configured to display the virtual overlapping information 38, such as the operational information and the identification information, associated with the target components displayed in the target visual information of the portion of the machine 10. More specifically, the display unit 34 is configured to display the virtual overlapping information 38 using “augmented reality”. The term “augmented reality” herein refer to a technique in which a person's perception or view of the real or physical world is augmented with additional informational input. In the present disclosure, the real or physical world represents the portion of the machine 10 and the additional information represents the operational information and the identification information associated with the portion of the machine 10.

As illustrated in FIG. 3, the virtual overlapping information 38 associated with the target components, such as the hydraulic actuator 21 and the ground engaging members 16, is superimposed with the target visual information associated with the target components, such as the hydraulic actuator 21 and the ground engaging members 16, on the mobile inspection device 30. More specifically, the virtual overlapping information 38 associated with the target components, such as the hydraulic actuator 21 and the ground engaging members 16, is superimposed on the image of the portion, such as the target portion 23, of the machine 10 exhibiting the target components, such as the hydraulic actuator 21 and the ground engaging members 16. The operational information, such as the tire pressure and the tire temperature, and the identification information, such as “206718”, “TOOL2”, and “Wheel” is superimposed on the target visual information i.e. the image of the target portion 23 of the machine 10 exhibiting one of the target components as the ground engaging members 16. Similarly, the operational information, such as the fluid pressure and the fluid level, and the identification information, such as “205171”, “TOOL1”, and “hydraulic actuator”, is superimposed on the target visual information i.e. the image of the target portion 23 of the machine 10 exhibiting one of the target components as the ground engaging members 16.

Based on the operational information and the identification information displayed on the mobile inspection device 30 corresponding to the target visual information associated with the target components, the maintenance personal monitors health of the target components. For example, the operational information, such as the fluid pressure, displayed on the mobile inspection device 30 is higher than a threshold fluid pressure for the hydraulic actuator 21. In such an example, the maintenance personal may take an appropriate action, such as repairing the hydraulic actuator 21 or replacing the hydraulic actuator 21. Based on the replacement or repairing of the target components, such as the hydraulic actuator 21, the controller 28 manages the bill of material of the components. More specifically, if one of the target components, such as the hydraulic actuator 21, is replaced, the controller 28 updates the bill of material with the operational information and the identification information pertaining to a new target component, such as a new hydraulic actuator.

### INDUSTRIAL APPLICABILITY

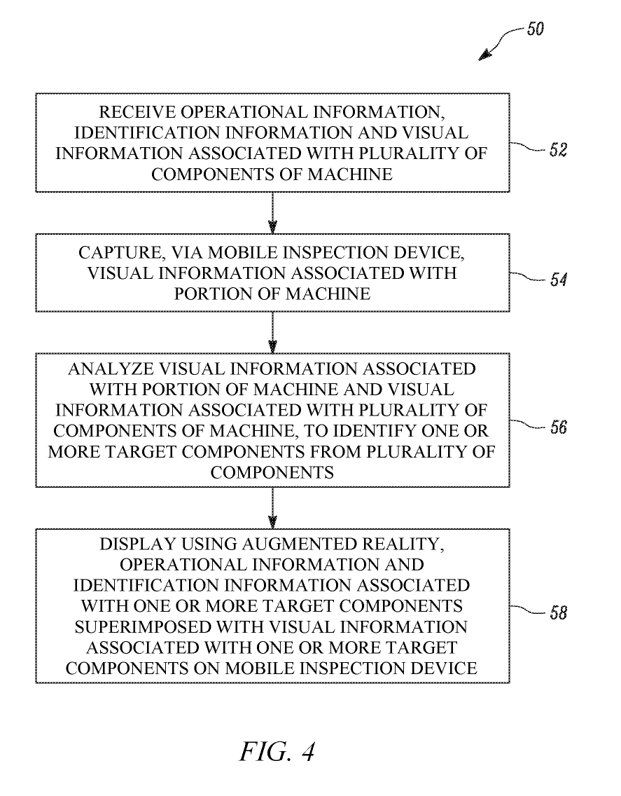

The present disclosure relates to a method 50 for managing health of the machine 10. FIG. 4 is a block diagram for the method 50 for managing health of the machine 10, according to an embodiment of the present disclosure. For the sake of brevity, the aspects of the present disclosure which are already explained in detail in the description of FIG. 1, FIG. 2, and FIG. 3 are not explained in detail with regard to the description of the method 50.

At block 52, the method 50 includes receiving the operational information, the identification information, and the visual information associated with the components of the machine 10. The operational information, the identification information, and the visual information are indicative of health of the components of the machine 10. The operational information, the identification information, and the visual information include the operating status, the component name, the component serial number, the component service history, the component service schedule and the reference images. More specifically, the operational information is indicative of data pertaining to operating parameters, such as the fluid pressure, the motor speed, the temperature, and the fault codes, associated with the components of the machine 10. The identification information is indicative of data pertaining to identifying parameters, such as the component name, the component serial number, the component service history and the component name, associated with the components of the machine 10. The visual information is indicative of data pertaining to the reference images associated with the components of the machine 10. The operational information, the identification information, and the visual information are received by the controller 28 of the machine 10.

At block 54, the method 50 includes capturing, via the mobile inspection device 30, the target visual information associated with the portion of the machine 10. The portion of the machine 10 includes the target components. The image capturing unit 32 of the mobile inspection device 30 captures the target visual information associated with the portion of the machine 10. At block 56, the method 50 includes analyzing the target visual information associated with the portion of the machine 10 and the visual information associated with the components of the machine 10, to identify the target components from the components. The target visual information associated with the portion of the machine 10 and the visual information associated with the target components are analyzed, using any known image processing techniques, by the controller 28 of the machine inspection system 26.

At block 58, the method 50 includes displaying, using augmented reality, the operational information and the identification information associated with the target components superimposed with the target visual information associated with the target components on the mobile inspection device 30. The controller 28 transmits the operational information and the identification information associated with the target components to the display unit 34. The operational information and the identification information received by the display unit 34 are superimposed on the target visual information of the target components displayed on the mobile inspection device 30.

The method 50 and the machine inspection system 26 may be employed for any type of machine that performs operations associated with industries such as mining, construction, farming, transportation, or any other industry known in the art. Therefore, the method 50 and the machine inspection system 26 have a wide range of application across industries.

The method 50 and the machine inspection system 26 will notify the maintenance personal regarding health of the components of the machine 10. More specifically, by using the method 50 and the machine inspection system 26, the maintenance personal may inspect health of each of the components discretely. Also, the method 50 and the machine inspection system 26 provide instantaneous inspection of the components of the machine 10, and eliminate manual inspection of the components. This eliminates errors associated with manual inspection of large number of components and subcomponents of the machine 10.

The method 50 and the machine inspection system 26 also updates the operational information and the identification information associated with the components of the machine 10, if the component is replaced or repaired by the maintenance personal, thereby managing information indicative of health of the components of the machine 10. Further, the method 50 and the machine inspection system 26 also improve tracking of a replaced component for updating the operational information and the identification information of the replaced component.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A method for managing health of a machine, the method comprising:
receiving operational information, identification information and visual information associated with a plurality of components of the machine, wherein the operational information, the identification information, and the visual information are indicative of health of the plurality of components of the machine;
capturing, via a mobile inspection device, visual information associated with at least a portion of the machine, wherein the portion of the machine includes one or more target components;
analyzing the visual information associated with the portion of the machine and the visual information associated with the plurality of components of the machine, to identify the one or more target components from the plurality of components; and
displaying, using augmented reality, the operational information and the identification information associated with the one or more target components superimposed with the visual information associated with the one or more target components on the mobile inspection device.

2. The method of claim 1, further comprising updating the operational information, the identification information, and the visual information associated with the plurality of components of the machine based on replacement of the one or more target components, wherein the operational information, the identification information, and the visual information include at least one of an operating status, a component name, a component serial number, a component service history, and a component service schedule.
